(19) United States
(12) Patent Application Publication
(10) Pub. No.: US 2009/0251993 A1
(43) Pub. Date: Oct. 8, 2009

(54) SHEAR WAVE TRANSDUCER AND METHOD OF USING THE SAME

(75) Inventors: Richard E. Berris, JR., Chagrin Falls, OH (US); George R. Piscsalko, Rock Creek, OH (US)

Correspondence Address: Fay Sharpe LLP, 1228 Euclid Avenue, 5th Floor, The Halle Building, Cleveland, OH, 44115, US

(73) Assignee: Pile Dynamics, Inc.

(21) Appl. No.: 12/417,669

(22) Filed: Apr. 3, 2009

Related U.S. Application Data
(60) Provisional application No. 61/123,035, filed on Apr. 4, 2008.

(51) Int. Cl. G01V 1/50; G01V 1/52

(52) U.S. Cl. 367/29; 367/75

(57) ABSTRACT

A wave generating device and method of using the same wherein the device is for producing a shear wave in a ground layer wherein the generated wave emanates from a bore hole in the ground layer and passes through the ground layer toward a receiver spaced from the bore hole. This wave having a given waveform and the bore hole being defined by at least one bore wall that extends from a surface of the ground layer to a bottom extent of the bore hole. The device including a driver having an outer layer extending in a longitudinal direction along a longitudinal axis and having a radially outwardly facing surface generally parallel to the longitudinal axis which is configured to engage an associated bore wall of an associated bore hole. The driver further including a coil assembly fixed relative to the outer layer, an inner assembly configured to move relative to the coil assembly and the inner assembly having at least one magnetic field emitter producing an inner magnetic field and the coil assembly having at least one coil of wire wherein the at least one magnetic field passes through the at least one coil. The device further including an electrical connection between the at least one coil of the driver and an associated power source such that when the associated power source is in an on condition the outer layer vibrates longitudinally relative to the inner assembly thereby producing a wave in an associated ground layer extending outwardly from the device.

This application is directed to a shear wave transducer and a method of using the transducer to produce a shear wave in a ground layer. This application claims priority to provisional patent application Ser. No. 61/123,035 filed on Apr. 4, 2008 which is incorporated by reference herein.

### INCORPORATION BY REFERENCE

Devices used to create sound waves or other waves in a ground layer or other materials are known in the art and can be used for a wide range of purposes including test purposes for determining the consistency or composition of the material in which the wave passes. U.S. Pat. No. 3,995,501 to Wiley discloses a shear and compression wave testing and measurement device and is incorporated by reference herein as background material showing the same. U.S. Pat. No. 4,038,631 to Murphy discloses a method for generating and directing seismic shear wave energy in the earth and is incorporated by reference herein as background material showing the same. U.S. Pat. No. 4,245,172 to Shirley discloses a transducer for generation and direction of shear waves and is incorporated by reference herein as background material showing the same. U.S. Pat. No. 4,248,092 to Vasile discloses a method and apparatus for efficiently generating elastic waves with a transducer and is incorporated by reference herein as background material showing the same. U.S. Pat. No. 4,271,923 to Layotte et al. discloses a mobile device for generating acoustic shear waves in the earth and is incorporated by reference herein as background material showing the same. U.S. Pat. No. 4,289,030 to Alers et al. discloses a non destructive testing device utilizing horizontally polarized shear waves is incorporated herein as background material showing same. U.S. Pat. No. 4,295,214 to Thompson discloses an ultrasonic shear wave transducer and is incorporated by reference herein as background material showing the same. U.S. Pat. No. 4,310,066 to Won discloses a torsion shear wave generator and is incorporated by reference herein as background material showing the same. U.S. Pat. No. 4,327,814 to Erich, Jr. discloses a rotating eccentric weight application and method for generating coated shear wave signals and is incorporated by reference herein as background material showing same. U.S. Pat. No. 4,481,612 to Curran discloses seismic surveying using shear waves and is incorporated by reference herein as background material showing the same. U.S. Pat. No. 4,484,313 to Dennis discloses a system for measuring shear wave travel times and is incorporated by reference herein as background material showing the same. U.S. Pat. No. 4,559,827 to Kupperman, et al. discloses an ultrasonic shear wave couplant and is incorporated by reference herein as background material showing the same. U.S. Pat. No. 4,640,756 to Wang et al. discloses a method of making a piezoelectric shear wave resonator and is incorporated by reference herein as background material showing the same. U.S. Pat. No. 4,655,314 to Airhart discloses a vibratory seismic source for generating combined compressional and shear waves and is incorporated by reference herein as background material showing the same. U.S. Pat. No. 4,712,641 to Chelminski discloses a method and system for generating shear waves and compression waves in the earth for seismic surveying and is incorporated by reference herein as background material showing the same. U.S. Pat. No. 4,867,096 to Cole discloses a tubular shear wave source and is incorporated by reference herein as background material showing the same. U.S. Pat. No. 4,871,045 to Cole discloses a telescoping tube omni-directional shear wave vibrator and is incorporated by reference herein as background material showing the same. U.S. Pat. No. 5,018,598 to Sodich discloses an apparatus for generating seismic waves and is incorporated by reference herein as background material showing the same. U.S. Pat. No. 5,079,463 to Matsuyama discloses a fly wheel method of generating SH waves and is incorporated by reference herein as background material showing the same. U.S. Pat. No. 5,265,016 to Hanson et al. discloses a method of shear wave velocity estimation and is incorporated by reference herein as background material showing the same. U.S. Pat. No. 5,321,333 to Walden et al. discloses a torsion shear wave transducer and is incorporated by reference herein as background material showing the same. U.S. Pat. No. 5,386,168 to Kosinski discloses a polarization-sensitive shear wave transducer and is incorporated by reference herein as background material showing the same. U.S. Pat. No. 5,675,208 to Huang et al. discloses a lithium niobate piezoelectric transformer operating in thickness-shear mode and is incorporated by reference herein as background material showing the same. U.S. Pat. No. 5,948,993 to Ting et al. discloses an amplified shear transducer and is incorporated by reference herein as background material showing the same. U.S. Pat. No. 6,105,712 to Lieng et al. discloses a method for generating seismic shearing waves in a subterranean formation and is incorporated by reference herein as background material showing the same. U.S. Pat. No. 6,518,689 to Yerganian discloses a piezoelectric wave motor and is incorporated by reference herein as background material showing the same. U.S. Pat. No. 6,826,285 to Azima discloses a bending wave loud speaker and is incorporated by reference herein as background material showing the same. U.S. Pat. No. 7,053,529 to Knowles discloses a Torsional acoustic wave sensor as background material showing the same. U.S. Publication No. US 2002/0044668 to Azima discloses a bending wave loud speaker and is incorporated by reference herein as background material showing the same. U.S. Publication No. US 2006/0285439 to Haugland discloses a shear wave velocity determination using evanescent shear wave arrivals and is incorporated by reference herein as background material showing the same. U.S. Pat. No. 4,103,756 to Trulio et al. discloses a stress wave generator and is also incorporated by reference herein as background material showing the same. U.S. Pat. No. 6,301,551 to Piscalco discloses a remote pile driving analyzer and is also incorporated by reference herein as background material showing the same. U.S. Pat. No. 4,705,137 to Fair discloses a marine shear wave vibrator and is also incorporated by reference herein as background material showing the same. U.S. Pat. No. 4,662,473 to Betz discloses a vibratory seismic source for generating combined compressional and shear waves and is also incorporated by reference herein as background material showing the same.

Also incorporated by reference herein is the Specifications for Mechanical System Vibration Isolation & Seismic Restraint by Vibration Mountings & Controls, Inc. of New Jersey which is incorporated by reference for showing isolation systems.

### BACKGROUND OF THE INVENTION

As is shown in the patents incorporated by reference above, producing a wave in a desired media, such as a ground layer, is known in the art. These waves can be used to test a wide variety of materials to determine the consistency of these materials or a wide range of other physical properties. As will be discussed in greater detail below, the invention of this application has been found to work particularly well in ground layers wherein much of this disclosure will be directed to earth or ground applications. However, this application is not intended to be limited to ground applications. With respect to these ground applications, it has been found that a shear wave can be used to effectively test a region of earth or ground to determine certain physical properties of this ground layer. These and other materials in which the waves are transmitted will hereinafter be collectively referred to as a “ground layer.”

In addition, the invention of this application has also been found to work particularly well with vertically extending bore holes wherein much of the application discusses these vertical bore holes and vertical shear waves. However, this invention and this application is not intended to be limited to vertical bore holes and can be used in connection with bore holes oriented in any plane including, but not limited to horizontal bore holes and even angular bore holes. Further, while it may be preferred that these bore holes are straight, this is also not a requirement in this application and should not be limited thereto.

Prior art testing devices generate the shear wave by impacting the ground layer with a hammer-like device to produce the shear wave. This hammer device needs to have a significant amount of impact load to produce the needed shear wave. Thus, these devices are typically large and heavy devices, often attached to trucks or other large vehicles, which support a large hammer or ram which impacts the ground layer. In order to prevent the hammer or ram from penetrating the ground, large rigid plates, typically metal plates, are placed on the ground layer at the impact zone. As can be appreciated, these devices can be expensive and can be very difficult to position at a desired testing location. Often, these testing locations are remote and large vehicles may not be capable of being maneuvered into these remote locations. Further, once these vehicles are positioned at these remote locations, they often become stuck in the rough terrain or soft soil which results in significant costs to free the vehicle from the rough terrain.

In addition to the above, the shear wave produced by these devices emanates from a point at the surface of the ground layer as opposed to points beneath the surface of the ground layer wherein testing at different locations or depths below the surface level can allow for a more thorough testing of the ground layer.

### SUMMARY OF INVENTION

In accordance with the present invention, a wave generating device for producing a shear wave in a ground layer is provided wherein this device includes an elongated driver that extends in a bore hole to create a shear wave that extends in the longitudinal direction of the bore hole and travels away from the bore hole.

In this respect, provided is a wave generating device for producing a shear wave in a ground layer wherein the generated wave emanates from a bore hole in the ground layer and passes through the ground layer toward a receiver spaced from the bore hole. This wave having a given waveform and the bore hole being defined by at least one bore wall that extends from a surface of the ground layer to a bottom extent of the bore hole. The device including a driver having an outer layer extending in a longitudinal direction along a longitudinal axis and having a radially outwardly facing surface generally parallel to the longitudinal axis which is configured to engage an associated bore wall of an associated bore hole. The driver further including a coil assembly fixed relative to the outer layer and an inner assembly configured to move relative to the coil assembly. Further, the inner assembly has at least one magnetic field emitter producing an inner magnetic field and the coil assembly has at least one coil of wire wherein the at least one magnetic field passes through the at least one coil. The device further including an electrical connection between the at least one coil of the driver and a power source such that when the power source is in an on condition the outer layer vibrates longitudinally relative to the inner assembly thereby producing a wave in an associated ground layer extending outwardly from the device.

According to another aspect of the present invention, the system can further include a power source and the power source includes an electronic wave emitter and an amplifier having an electronic input and output, the input being in electrical connection with the wave emitter and the output being in electrical connection with the at least one coil of the driver.

According to a further aspect of the present invention, the system can further include a side load presser joined to driver and this presser can selectively urge the outwardly facing surface of the driver transversely in the longitudinal direction such that this surface is forced against the associated bore wall.

According to yet another aspect of the present invention, the presser includes a housing and an actuator fixed relative to the housing wherein the actuator can include a linear actuator that extends in the longitudinal direction used to actuate a cam and a cam follower such that movement of the linear actuator in the longitudinal direction moves a presser plate in the transverse direction and the driver can be joined to the presser plate. In yet another embodiment, the presser can further include a hanger joined to the frame and this hanger can support the device in the associated bore hole.

According to yet a further aspect of the present invention, the device can further including a drive motor and a hanging support joined to the drive motor for raising and lowering the driver longitudinally in the bore hole such that the drive motor and the side load presser are controlled by a computing device that automatically operates the device based on designated operating parameters to produce a shear wave at multiple locations in the associate bore hole at different times.

According to yet another aspect of the present invention, provided is a method of using this device to measure at least one parameter in a layer of ground. This method including the steps of forming a bore hole in a ground layer; providing a wave generating device according to one or more embodiments of this application; providing a receiver and positioning this receive at a given location spaced from the bore hole; positioning the generating device in the bore hole at a given location in the longitudinal direction; urging the generating device against the bore wall to form a frictional engagement between the radially outwardly facing surface and the bore wall; vibrating the outer layer relative to the inner assembly thereby producing a wave in the longitudinal direction in the ground layer; and receiving the wave with the receiver.

### BRIEF DESCRIPTION OF THE DRAWINGS

The foregoing, and more, will in part be obvious and in part be pointed out more fully hereinafter in conjunction with a written description of preferred embodiments of the present invention illustrated in the accompanying drawings in which:

FIG. 1 is a vertical section view of a ground layer with two bore holes and a wave generating device according to the present invention that includes a single driver within one bore hole and a single receiver within the second bore hole;

FIG. 2 is a vertical section view similar to that of FIG. 1 wherein this embodiment includes a depth control for the driver and the receiver;

FIG. 3 is a vertical section view similar to FIG. 1 also with a single driver used in connection with multiple receivers spaced vertically in the second bore hole;

FIG. 4 is a horizontal section view taken at a given depth in the ground layer showing the driver in FIG. 1 used in connection with multiple receivers spaced about a driver axis;

FIG. 5 is an enlarged partially sectioned view of the driver shown in FIG. 1 wherein the driver is not in ground contact;

FIG. 6 is a sectional view taken along line 6-6 in FIG. 5;

FIG. 7 is an enlarged view of the driver in a bore hole wherein the driver is in ground contact;

FIG. 8 is a sectional view taken along line 8-8 in FIG. 7;

FIG. 9 is an enlarged vertical section view taken through the driver;

FIG. 10 is an enlarged view partially sectioned of the upper portion of the driver;

FIG. 11 is a partially section view of another embodiment of this application in a bore hole not in ground contact;

FIG. 12 is a partially section view of the wave generating device of FIG. 11 in a bore hole and in ground contact;

FIG. 13 is a sectional view taken along line 13-13 in FIG. 11; and,

FIG. 14 is a sectional view taken along line 14-14 in FIG. 12.

### DESCRIPTION OF PREFERRED EMBODIMENTS

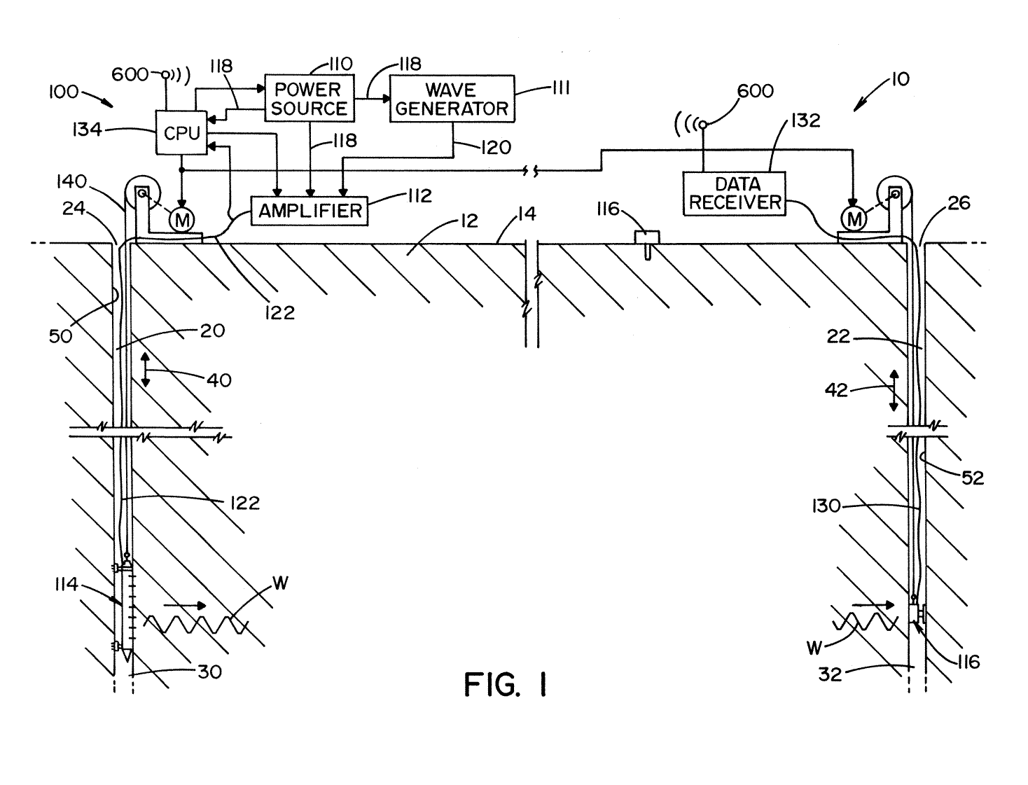

Referring now in greater detail to the drawings wherein the showings are for the purpose of illustrating preferred embodiments of the invention only and not for the purpose of limiting the invention, FIG. 1 shows a testing site 10 which includes a ground layer 12 extending downwardly from a surface 14. Testing site 10 further includes a first bore hole 20 and a second bore hole 22 which are generally parallel to one another and which extend from ground openings 24 and 26, respectively, to bottom extents 30 and 32, respectively. First bore hole 20 extends in a longitudinal direction 40 and bore hole 22 extends in a longitudinal direction 42 wherein directions 40 and 42 are generally parallel to one another so that the timing of any wave propagating from the first bore hole to the second bore hole can be accurately timed or analyzed and that this information can be used to obtain data or information about the material composition of ground layer 12 between the first and second bore hole. Again, FIG. 1 is intended to show a single particular arrangement in which the invention of this application can be used and, as was referenced above, the invention of this application is not limited to vertical bore holes or this site arrangement. However, for description purposes only, these bore holes merely describe the vertical bore holes wherein longitudinal directions 40 and 42 are vertically extending. But, this is not a requirement for this application.

The spaces between the first and second bore holes can be any spacing to test a desired ground layer. However, as is known in the art, increasing the distance between the bore holes requires additional power to produce a stronger waveform such that the wave can travel from the first bore holes to the second bore hole. In one embodiment, the spacing between the first bore hole and the second bore hole is approximately 100 feet. First hole 20 includes a first bore wall 50 and second bore hole 22 includes a second bore wall 52.

In addition, while FIG. 1 shows the wave extending from the first bore hole to the second bore hole, this also is not a limitation and is only for descriptive purposes. In one embodiment, the wave is propagated from both bore holes to perform the test in both directions.

FIG. 1 further shows a wave generating device 100 which generally includes a power source 110, a wave generator 111, an amplifier 112, a driver 114 and a receiver 116 which all will be discussed in greater detail below. More particularly, power source 110 can be any power source known in the industry for generating electrical power. This can include battery systems known in the art, on site power such as a portable generator or even line power. This power source can provide the power to all operating systems in the device or even selected systems, such as those not in the bore hole. Power source 110 can power wave generator 111 by way of connection 118 such that source 111 generates a desired waveform and communicates this waveform through electrical a connection 120 to amplifier 112. Then, amplifier 112 increases the strength of the wave produced by power source 110 and transmits this strengthened wave through electrical connection 122 to driver 114. Power source can also power amplifier 112 and a computer 134 also by way of connection 118. Wave generator 111 and amplifier 112 can be any systems known in the art for generating and amplifying a wave. Further, as will be discussed in greater detail below, the wave produced and amplified can be a wide variety of waves including those known in the art.

As will be discussed in greater detail below, driver 114 then receives this signal and vibrates vertically thereby producing wave W in ground layer 12 which is sent out in all directions from driver 114 and this outwardly extending wave W is eventually received by receiver 116. It should be noted that receiver 116 can be any receiver known in the art wherein, in the nature of brevity, further details on the inner workings of receiver 116 will not be discussed in this application except for its configuration and arrangement within the second bore hole.

Once receiver 116 receives wave W, this information is communicated through electrical connection 130 to a data receiver 132 which can be any type of data receiving device known in the art including, but not limited to, a computer, a laptop computer, a transmitting device in communication with a remote data storage device (not shown) or even with a local operating system or computer 134 which will also be discussed in greater detail below. Computer 134 can be joined to some or all of the operating systems in this application and can be a single computer or multiple computers and/or operating systems onboard in one or more of the devices in the system.

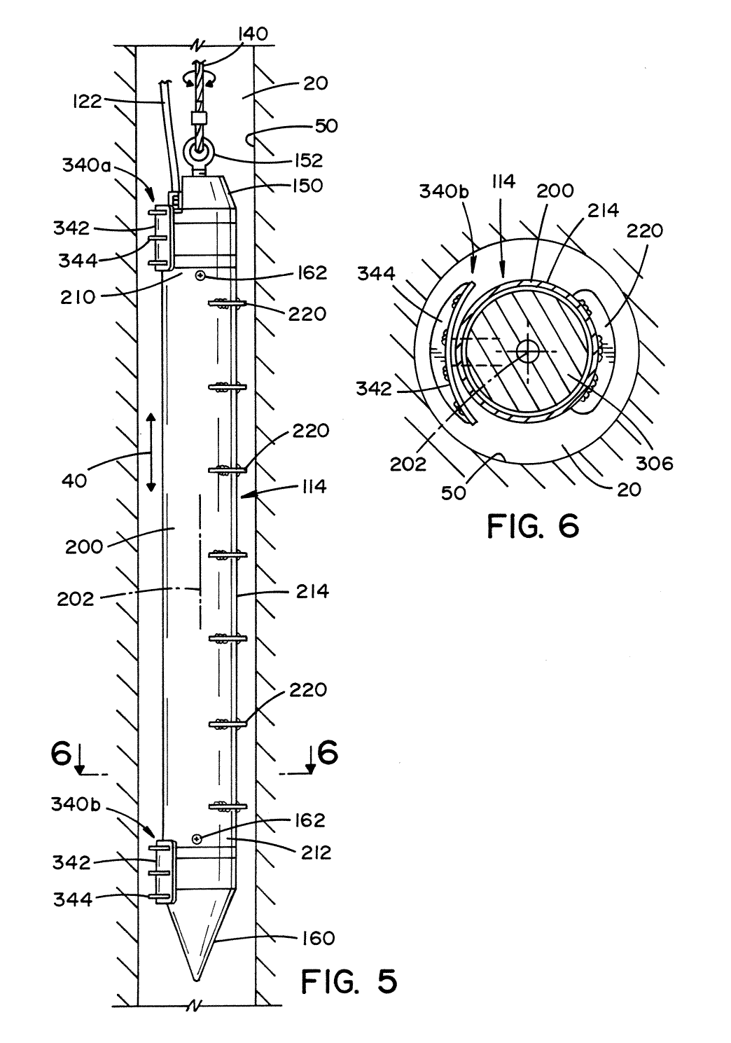

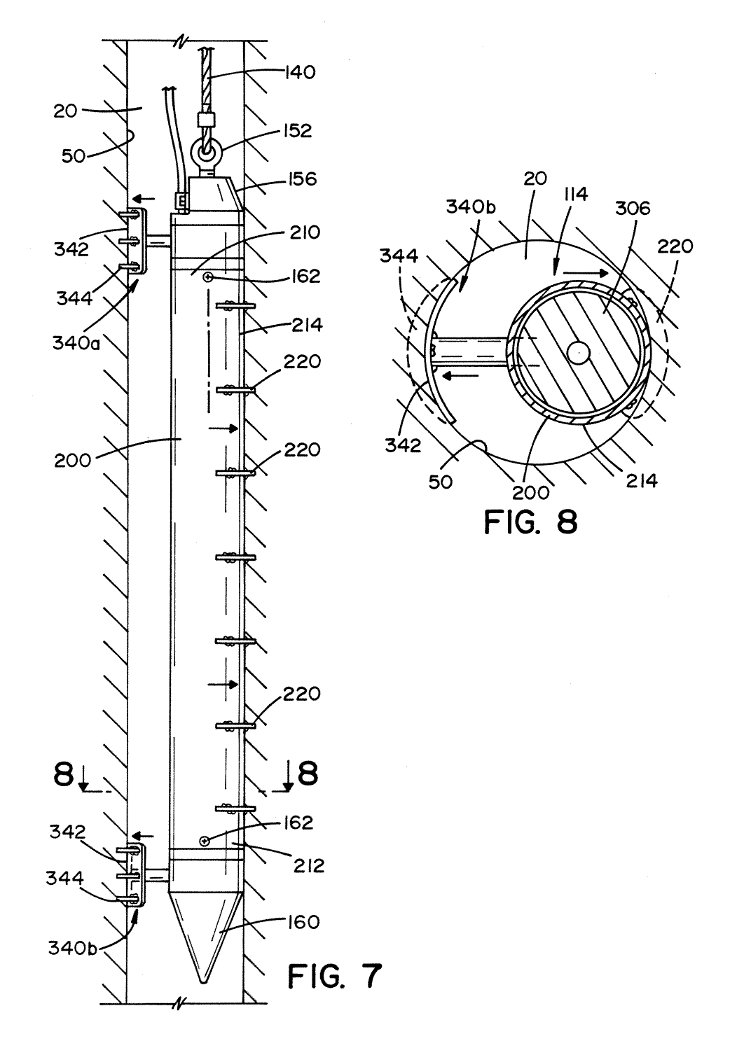

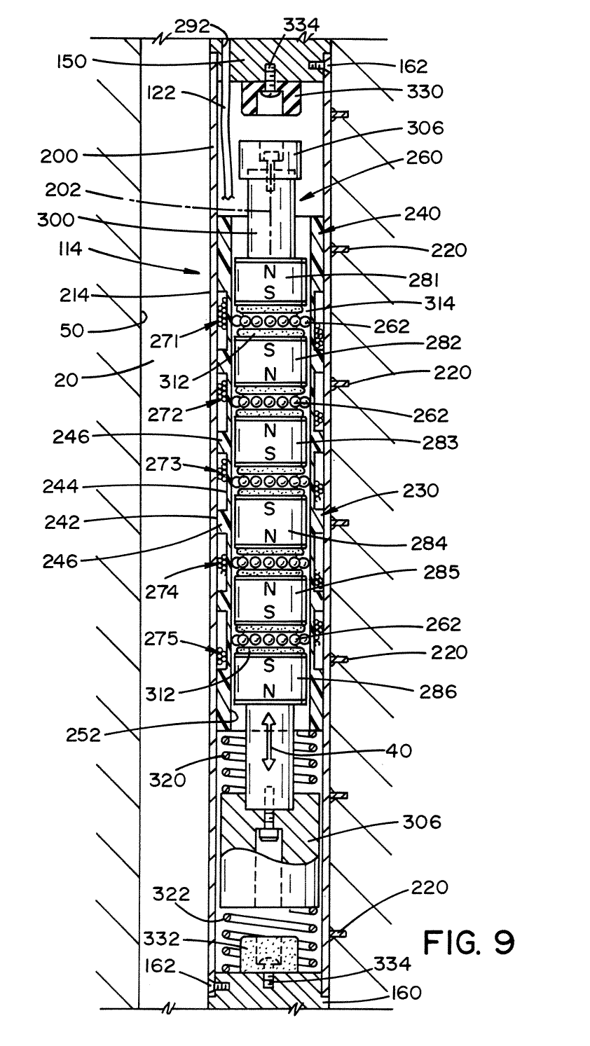

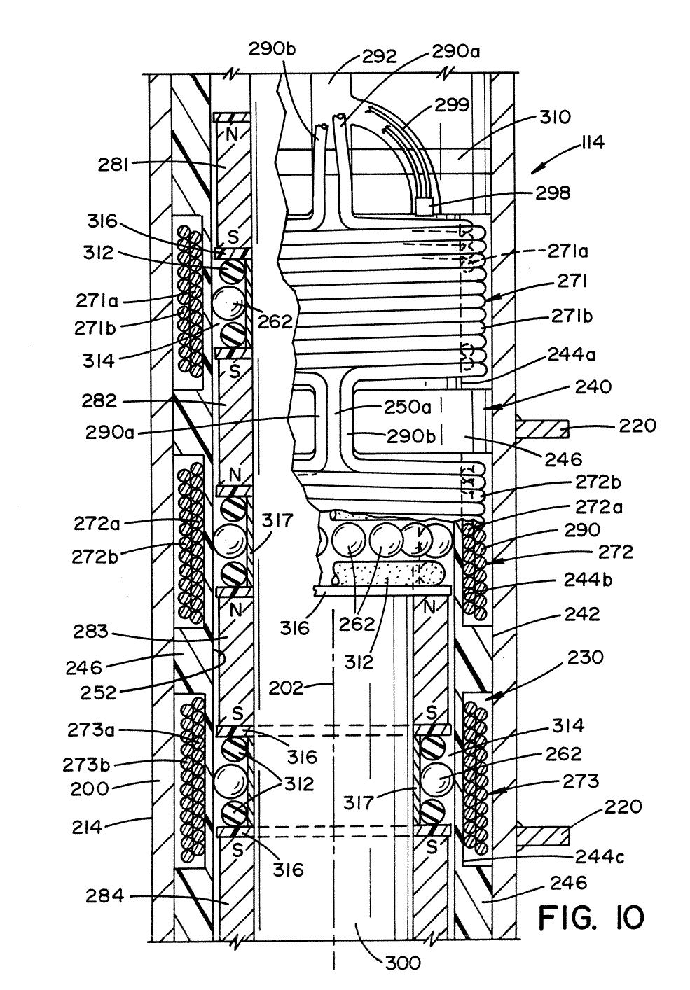

With reference to FIGS. 5-10, wave generating device or driver 114 can be a generally cylindrical device configured to extend, without resistance (in one embodiment), into one of the first and second bore holes. As is shown, driver 114 extends into first bore hole 20 and is supported by a cable 140. As will be discussed in greater detail below, cable 140 can be automatically driven by a motor M or can be manually operated to move driver 114 in longitudinal direction 40 within bore hole 20. Driver 114 can include a top support or cap 150 which includes a hanger 152 wherein cable 140 is connected to hanger 152 to support the driver within the bore hole. Driver 114 can further include a bottom cap 160 which can have a tapered configuration to help the driver be lowered within the hole. In particular, in one embodiment, the driver is forced into a hole that is smaller than the driver wherein it is press fitted into the hole. In this embodiment, the cone shaped cap aids in the forcing of the device into the ground. However, bottom cap 160 can also be a flat cap without detracting from the invention of this application which is a preferred cap configuration for some embodiments. The top and bottom caps can be secured to driver 114 by any means known in the art including, but not limited to, fasteners 162.

Driver 114 further includes an outer layer 200 which extends about a longitudinal axis 202. In one embodiment, outer layer 200 is coaxial with axis 202 and is generally cylindrical extending from a top extent 210 to a bottom extent 212. Outer layer can be joined to caps 150 and 160 by fasteners 162 as is described above. Outer layer 200 further includes a radially outwardly facing surface 214 which also extends about longitudinal axis 202. Outwardly facing surface 214 is configured such that at least a portion of this surface can engage bore wall 50 of first bore hole 20. This frictional engagement can be enhanced by one or more frictional enhancers 220 that can be formed by the frictional plates as is shown in these figures, or can be formed by other surface textures, surface ridges, outwardly facing threads or other configurations designed to frictionally lock this surface to the bore hole which has been found to enhance the wave produced by driver 114.

Driver 114 further includes a coil assembly 230 which is joined relative to outer layer 200 which together form an outer mass which will be described in greater detail below. Coil assembly 230 can be joined to the outer layer by any method known in the art including, but not limited to, adhesives and fasteners. Coil assembly 230 can be formed by a coil support 240 having an outwardly facing surface 242 configured to engage the outer layer. Coil support can be formed by any material known in the art and it has been found that the performance of driver 114 is enhanced if the outer mass is minimized. Thus, coil support 240 can be produced by a lightweight material to enhance these characteristics. However, as will be discussed in greater detail below, this coil support material cannot be a conductor of electricity in that it supports the coils used to create the vibrating motion which will also be discussed in greater detail below. Thus, it has been found that lightweight and durable polymers can be used to manufacture this coil support. In particular, it has been found that a polymer such as, DELRIN and Nylon work well for this component. However, this application is not to be limited to this particular polymer and that other non-conductive materials which are lightweight can be used with the driver of this application. Further, even conductive materials could be used in combination with the use of insulating materials to shield the current in the coils from the support. Coil support 240 includes outwardly facing troughs 244 separated by ridges 246 which extend about axis 202. These ridges include pass throughs 250 which can be a slot which will be discussed in greater detail below.

Coil support 240 can further include an inner passage 252 extending through the support and which can be a cylindrical passage, but can have other configurations without detracting from the invention of this application. Inner passage 252 is configured to support an inner assembly 260 which will be discussed in greater detail below. As is shown in these figures, inner passage 252 extends in the longitudinal direction and has a diameter greater than the maximum outer diameter of inner assembly 260 wherein bearings 262 can be used to allow inner assembly 260 to freely move relative to coil assembly 230. However, while ball bearings are used in this particular embodiment for bearings 262, any bearings known in the art could be used to allow the free movement of inner assembly 260 relative to coil assembly 230 and thus outer layer 200.

Coil assembly 230 further includes coils 271 through 275 which are wrapped in troughs 244 about longitudinal axis 202. However, while five coils are shown, more or less coils can be used without detracting from the invention of this application. The number of coils which are used in the driver can be adjusted to produce a desired strength of wave W. In this respect, a number of factors can determine the strength of the wave. These factors include changing the power produced by amplifier 112; the diameter of the coils; the length of the coils; the number of turns in each coil; the number of coils which are utilized in the driver; and/or the magnetic field strength of the magnets or electromagnets. As can be appreciated, increasing the diameter of the coils can adversely impact the ability of the driver to be placed in standard bore holes. Thus, it has been found that increasing the number of coils used in the driver which only increases the overall length of the drive can effectively create the desired strength of the wave without adversely increasing the overall diameter of the driver.

These coils work in combination with each other to multiply the moving force of the coil assembly by wrapping each adjacent coil in a different direction about axis 202. In this respect, coils 271, 273, and 275 can be wrapped, when viewed from top to bottom of the driver, counter clockwise about axis 202 while coils 272 and 274 are wrapped clockwise. This alternating wrapping works in combination with magnets 281-286 to create a unified and multiplied force to produce the oscillation of the inner assembly relative to the coil assembly as will be discussed in greater detail below.

Coils 271-275 can be formed by a single wire 290 wherein wire 290 can be formed by two legs 290a and 290b and which is directed from one trough/coil to the next by way of pass throughs 250.

In greater detail, wire leg 290a enters through top opening 292 into trough 244A where it is wrapped about driver axis 202 counterclockwise in trough 244a to form an inner coil portion 271a of coil 271. Leg 290a then passes through trough 250a and enters trough 244b wherein it is wrapped clockwise about axis 202 to form a lower coil portion 272a of coil 272. This configuration of alternating wrapping directions is continued throughout the remaining troughs and leg 290a forms a lower coil section or portion of each and alternates between a counterclockwise winding and a clockwise winding for each adjacent coil. Once wire 290 reaches the final coil, it begins its winding back towards top opening 292 and first coil 271 wherein section or portion b is wrapped over top of the lower coil portion forming an upper coil portion such as upper portion 271b which is wrapped in the same direction about axis 202 wherein coil section 271b is wrapped counterclockwise over top of section 271a and coil portion 272b is wrapped clockwise over section 272b.

Driver 114 can further include a heat sensor 298 positioned adjacent to one or more coils within the driver. In this embodiment, heat sensor 298 is positioned adjacent coil 271. This sensor allows for the monitoring of the coil temperature of driver 114 thereby allowing the operator of the device to ensure that the coils do not overheat which can damage the unit. Electrical connection 299 can be used to power and/or communicate the temperature of the coil to operating system or CPU 134 in any way known in the art. In yet another embodiment, the drivers of this application can include a compass, such as an electronic compass, to allow the operation to determine the rotational orientation of the driver about axis 202. This information can be used to properly align the driver in the bore hole such that it is forced against the bore wall facing a desired direction, such as the bore wall facing the receiver, to maximize the strength of the wave in the desired direction. This, along with other factors, can be used to achieve a readable wave over 100 feet away from the driver.

Magnets 281-286 work in combination with the coils to produce the oscillating used to create the wave in the ground layer. In this respect, the magnets are fixed to rod 300 and can be fixed by any means known in the art, including, but not limited to, braising, welding, adhesives, notching, and fasteners to form a portion of inner assembly 260. Inner assembly 260 can further include one or more weights 306 joined to rod 300 by similar or other means to increase the weight of the inner assembly mass or inner mass such that the inner mass can be more than the outer mass of the device which improves the efficiency of the driver. By increasing the weight of the inner assembly relative to the outer mass, the motions of the inner assembly is reduced relative to the outer portions of the driver. However, as can be appreciated, the inner assembly will be subjected to some vibrations; however, increase in the weight of the inner assembly minimizes the movement of the inner assembly and maximizes the movement of the outwardly facing surface 214 which is used to create the wave in the ground layer. Accordingly, the inner assembly has an inner mass which is, based on the use of weights and materials, greater than the outer mass of the coil assembly and the outer layer. The mass of the inner assembly can be maximized based on the confines of the system to increase the vibrating efficiency of the system.

Similar to the alternating windings of the coils in the coil layer, magnets 281-286 are also alternated such that each adjacent magnet has a common pole facing one another. For example, magnet 282 has a south pole facing upwardly and a north pole facing downwardly while the adjacent magnets on either side have an upwardly facing north pole and a downwardly spacing south pole. As with the coil arrangement, this alternating pole configuration produces a power multiplying conditions wherein each section of the driver adds strength to the wave produced as opposed to cancelling each other out. This allows a small diameter driver to have the strength needed to produce a wave that can travel through over 100 feet of soil.

Inner assembly 260 can further include bearing guides 312 on either side of bearings 262 described above to help maintain the bearings in a free moving condition within a bearing pocket 314. As a result of this bearing configuration, the inner assembly can move freely relative to the outer assembly. Bearing guides 312 can be an O-ring configured to maintain the position of the bearings in the bearing pocket and which can isolate the bearings from the adjacent magnets. Inner assembly 260 can further include side load O-rings 316 adjacent to bearing guides 312. In addition, bearing pockets 314 can include bearing sleeves 317 which can have several functions. In one embodiment, they can be used to help reduce the wear on the inner rod or allow for easy replacement of a wear component. In other embodiments, they can be used as as a shim or spacer to create the proper fit of the bearings between rod 300 and passage 252 which allows the use of commercially available rods for rod 300.

Driver 114 can further include one or more biasing members 320 that can be used to force the inner assembly into a neutral or home condition either when power is turned off or during the operation of the driver. This configuration can be used to ensure that the magnetic fields produced by the magnets are properly aligned in the center of the corresponding coil to maximize the force produced by the system. Biasing members 320 and 322 can be any biasing members known in the art including, but not limited to, coil springs, elastomeric springs, and leaf springs.

Driver 114 can also include a top and/or a bottom bumper 330 and 332, respectively. These bumpers can be used to limit the travel of the inner assembly relative to the coil assembly to prevent damage from over extension. Further, they can be used in combination with the biasing members 320 and 322 to help control the movement of the inner assembly relative to the coil assembly. In one embodiment, bumpers 330 and 332 are joined to the end caps. This can be done by any means known in the art including, but not limited to, fasteners 324, adhesives, and shape fitting connections. Further, in an embodiment not shown, the bumpers and biasing members can be combined together.

Driver 114 further includes at least one side load presser 340. In the embodiment shown in FIG. 5, driver 114 includes side load pressers 340a and 340b wherein presser 340a is near the top portion of the driver and presser 340b is near the bottom portion of the driver. As will be discussed in greater detail below with respect to other embodiments of this application, these pressers can be configured to be a single presser having a length more equal to the length of driver 114. In yet other embodiments, additional pressers could be used.

As with outer surface 214, pressers 340 include an outer surface or engagement region 342 which can include frictional enhancers 344 that can include texturing, surface ribs, outwardly facing threads, plates or the like. However, these frictional enhancers are not required and these side load pressers can be any configuration of actuating units to produce the required side load and force outer surface 214 against the bore wall without detracting from the invention of this application.

While not shown, side load pressers 340a and 340b can further include isolation connections between the pressers and the remaining components of the driver to maximize the outer oscillation of outer surface 214 to the driver during operation.

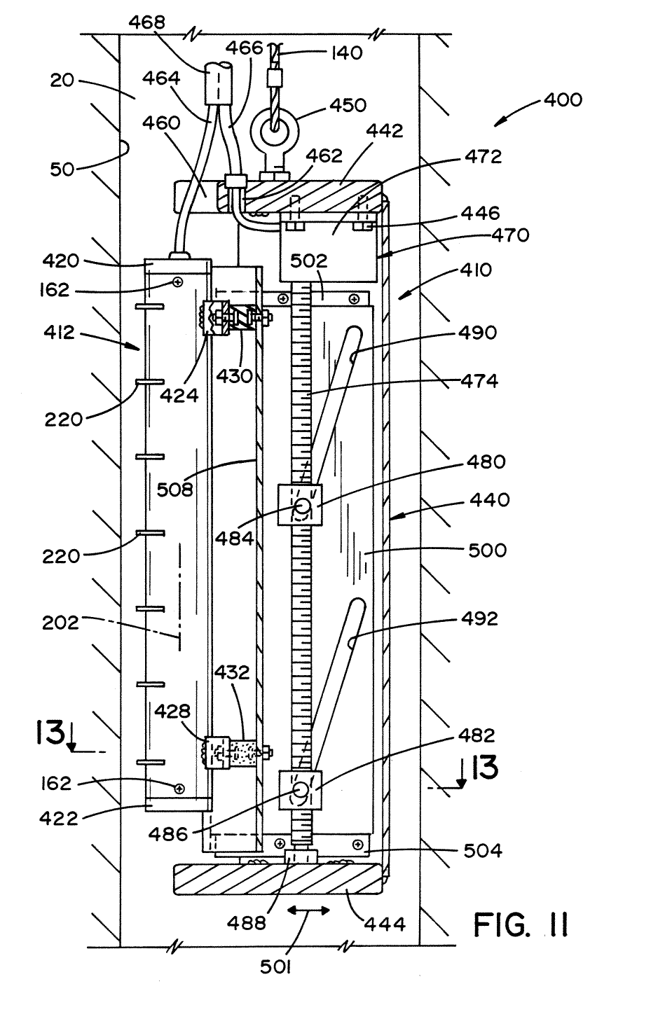

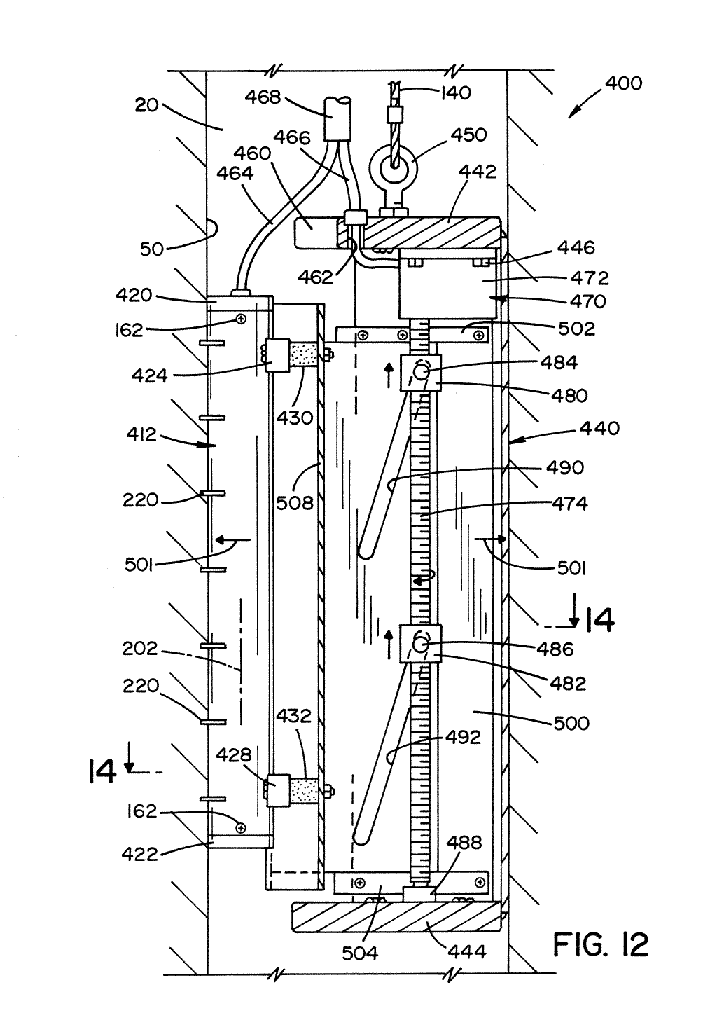

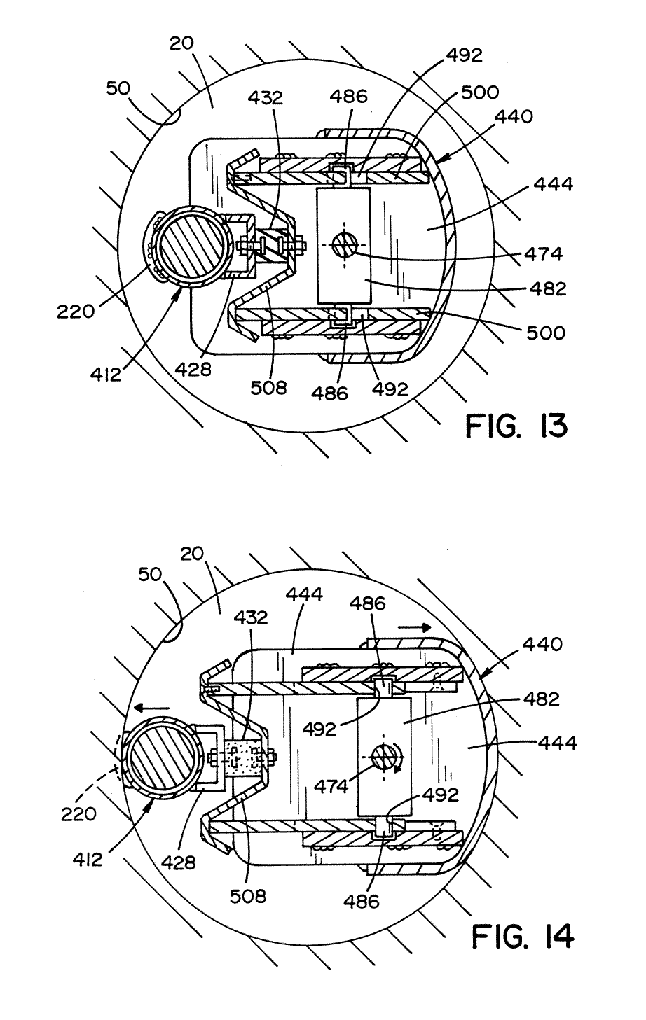

With reference to FIGS. 11-14, shown is a wave generating device 400 which includes a presser unit 410 that supports a driver 412 within the bore hole. Driver 412 is similar to driver 114 discussed above and, therefore, will not be discussed in detail in the interest of brevity. However, two aspects of driver 412 have been changed. In this respect, end caps 420 and 422 are the flat style end caps referenced above. In addition, driver 412 includes side mounts 424 and 428 where isolation bolts 430 and 432 are used to join driver 412 to presser 410 which will be discussed in greater detail below.

Presser 410 includes a frame or housing 440 which is essentially the frame for device 400 and which includes a top cap 442 and a bottom cap 444. Top cap 442 includes a hanger 450 to allow cable 140 to support device 400 (both pusher 410 and driver 412) within the bore hole. As with all hangers discussed in this application, hanger 450 can be any hanger known in the art and can be joined to top cap by any means known in the art including, but not limited to, a threaded engagement with the top cap. Top cap 442 can further include wire openings such a slot opening 460 and a through hole opening 462 to allow one or more communication and/or power wires to pass through top cap 442 to allow communication and power by the remaining components of the device. In this embodiment, electrical connection 464 is the communication and/or power connection for driver 412 and electrical connection 466 is the communication and/or power connection for pusher 410. Both connections 464 and 466 can be directed to the surface by way of a cable housing 468 to protect these connections from the harsh conditions associated with this kind of testing equipment.

However, while it has been found that wired communications work well with the invention of this application, this application is not to be limited to wired systems wherein wireless systems can replace any of the wired systems shown or described in this application without detracting from the invention of this application. As with other embodiments, device 400 can include any of the power sources, amplifier and/or computer devices described above with respect to device 100 without detracting from the invention of this application. Further, a power source can also be positioned in device 400 to operate one or more systems and to allow wireless communication.

Caps 442 and 444 can be joined to the remaining portions of the frame by any means known in the art including, but not limited to welding, locking shapes and fasteners. However, it has been found that the ability to remove one or both caps can be beneficial wherein one embodiment includes the caps being secured by way of fasteners 446 as is shown on top cap 442.

Presser 410 further includes an actuator 470 which can be, as is shown, a linear actuator that is an electric system having a motor 472 and an actuation screw 474 wherein the rotation of screw 474, by way of motor 472, moves threaded bushings 480 and 482 which in turn drives cams 484 and 486 in cam follower slots 490 and 492. As a result of the rotation of screw 474 and the resulting longitudinal movements of threaded bushings 480 and 482, a presser piston 500 moves in transverse direction 501. Actuator 470 can further include a lower bearing or bushing 488 joined to frame 440 and/or cap 444 to maintain the proper alignment of screw 474 and to help transfer the side loads generated by the presser plate into the frame of the pusher.

Presser piston can be guide by bearings 502 and 504 which can be joined to frame 440. Bearings 502 and 504 can be any bearings known in the art including, but not limited to, polymer bearings having a low coefficient of friction. Joined to presser piston 500 is a presser plate 508 which is used to connect the driver 412 to the presser. Thus, the actuation of actuator 470 can be used to force driver 412 in transverse direction 501 thereby pressing the driver against bore wall 50. Once the presser is forced against the bore wall with a desired amount of force, the power can be fed to the driver thereby oscillating the driver and creating the desired shear wave within the ground surface. The use of isolation bolts 430 & 432 reduces the amount of this vibration that is translated to presser 410.

While one presser arrangement is shown, this application is not limited to a single mechanical arrangement and any device can be used to press the driver into contact with the bore hole without detracting from the invention of this application. This can even include devices that are powered from the weight of the driver or powered from the surface. For example only, rotation of a cable or other mechanism that joins the device to the surface can be used to actuate the system. In addition, the pressing force can be produced from one or more solenoids extending in either the longitudinal direction and/or the transverse direction, a pneumatically powered system or even a hydraulically powered system. The pneumatic and/or hydraulic pressure can be produced by an onboard supply or even a supply on the surface wherein the device of this application further includes one or more fluid lines extending from the ground surface to the device. It is also possible for the presser to be driven by other systems such as a rack and pinion arrangement could be used or even an air bladder. These and other systems can be used without detracting from the invention of this application.

In yet another embodiment, driver 114 is shaped to be pressed into a bore hole. In this respect, the bore hole can be configured to be similar to the diameter of outer surface 214 of the driver wherein the driver can be pressed into the hole and in this embodiment, a presser arrangement is not necessary to obtain the necessary ground contact between the driver and the ground layer. Further, the cable can be replaced with a rod to help force the driver into the hole or even the ground without a hole. The rod could then also be used to remove and/or reposition the driver after the test is completed. As discussed above, in this and other embodiments, the bottom cap can be shaped to help the driver be pressed into the ground. In yet another embodiment, the driver can have external threads which can be used to thread the driver into the ground. This can be either threading the driver into a small bore hole or in no bore hole at all depending on the soil composition and other factors.

The wave generating device of this application is made to allow the device to be lowered or pressed into a drilled bore hole in the ground. As described in other sections of this application, for illustration purposes only, this drilled bore hole is described and shown to be a vertically extending bore hole. However, this application is not to be limited to vertical bore holes. The device of this application can be used in connection with a wide range of bore holes including horizontal bore holes drilled into the side of a ground layer.

The driver portion of the invention of this application is an electromagnetic force driver constructed with the alternating coils of wires described above in combination with the use of permanent magnets. As can be appreciated, the permanent magnets described above with respect to the inner assembly could be replaced with electromagnets such as another set of coils that can also be alternating coils so that each section multiplies the strength of the driver as opposed to cancelling out the strength produced by adjacent coils.

In operation, once the driver portion is lowered into the bore hole to the desired depth, the presser unit is used to force the driver against one of the walls of the bore hole. While it may be preferred to have the driver pressed against the bore wall that faces the receiver, this is not a requirement for the invention of this application. When in engagement with the bore wall, power is supplied to the driver by way of the power source and this wave is amplified by the amplifier such that the outer layer of the driver vibrates based on the signal produced by the power source thereby creating a shear wave in the ground layer. Since the vibration is in the longitudinal direction, this shear wave is also in the longitudinal direction wherein the figures of this application show a vertical shear wave.

In order to maximize the vibration of the outer layer, extra weights or mass can be added to the inner assembly to reduce the amount of motion in the inner assembly and focus the motion to the outer layer. In view of the multiplying design of the magnets and the coils, a small diameter driver can be used within the bore holes which advantageously reduce the drilling diameter of the bore hole which, as is known, is easier and less expensive to form. Further, by reducing the outer mass of the driver's of this application, the efficiency of the driver is increased since the reaction force produced by the driver goes directly into the bore hole wall not the mass of the outer layer.

As is described above, the coil assembly of the drivers of this application is fixed relative to the outer layer of the driver and the magnets are fixed relative to the central rod. Based on the orientation of the magnets relative to the corresponding coils, a magnetic field between the magnets and the outer facing surface passes through the wire coils. Thus, when electric current flows through the coils, this causes a force between the coils and the magnets. This force is proportional to the current times the field strength of the magnet. In one embodiment, outer layer 200 is made from a magnetic material which can increase the magnetic field produced by the magnets within the driver. Again, the reversing polarity of the magnets coupled with the reverse winding of the coils make each section add strength to the adjacent section as opposed to cancelling out this strength. The configuration of the wave can be controlled by the power source which is fed then to the amplifier to increase the strength of this wave. As is discussed above, a wide range of waveforms can be utilized in connection with the device of this application.

All of the components of the device of this application can be configured to allow easy disassembly and reassembly so that the device of this application can be worked on in the field. As can be appreciated, problems can occur during operation wherein the disassembly and reassembly of the device can be advantageous. However, in other embodiments, the device can be a sealed and tamper proof device to prevent modification by an end user in the field.

Inner assembly 260 includes a central rod 300 which provides the structure for the inner assembly. As is stated above, the inner assembly and thus inner rod are guided by the bearing engagement between bearings 262 and inner passage 252 of coil assembly 230.

While not shown, the driver and/or the pusher can further include baffles, seals, covers, or other arrangements designed to prevent dirt or moisture from entering the workings of any of these devices without detracting from the invention of this application. Any form of moisture and/or debris barriers known can be used for any of the systems of this application.

One method of measuring according to an aspect of the invention relates to measurement of a parameter in a layer of ground and the includes the steps of:
Forming a first bore hole in a ground layer using any means know in the art including, but not limited to, drilling the bore hole.
Forming a second bore hole in the ground layer spaced from the first bore hole. Each bore hole being defined by at least one bore wall that extends from a surface of the ground layer to a respective bore extent of the bore hole in a vertical or a longitudinal direction;
Providing a wave generating device according to one or more of the embodiment described above for producing a wave in the first bore hole in the vertical/longitudinal direction;
Providing a receiver which can be any receiver know if the art. Further, as discussed above, this receiver can also include a presser arrangement according any of the embodiments of this application as discussed for the drivers;
Positioning the receiver in the second bore hole;
Positioning the driver or generating device in the bore hole at a given location in the longitudinal direction;
Urging the generating device against the bore wall to form a frictional engagement between the radially outwardly facing surface and the bore wall;
Vibrating the outer layer relative to the inner assembly thereby producing a wave in the longitudinal direction in the ground layer; and,
Receiving the wave with the receiver.

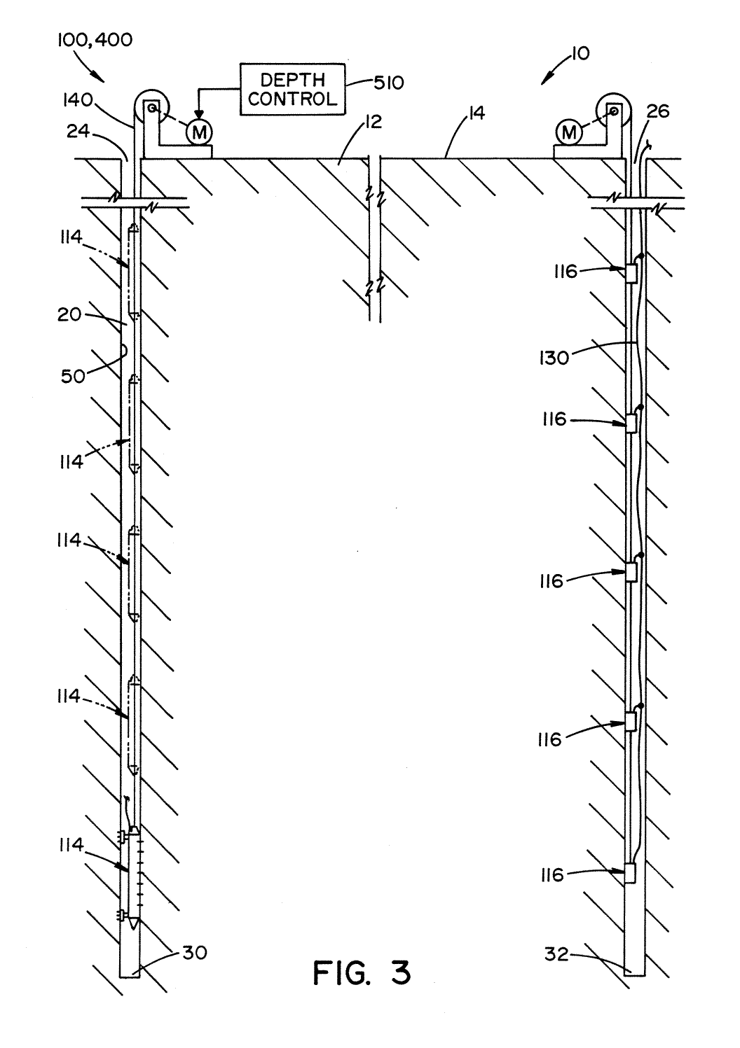

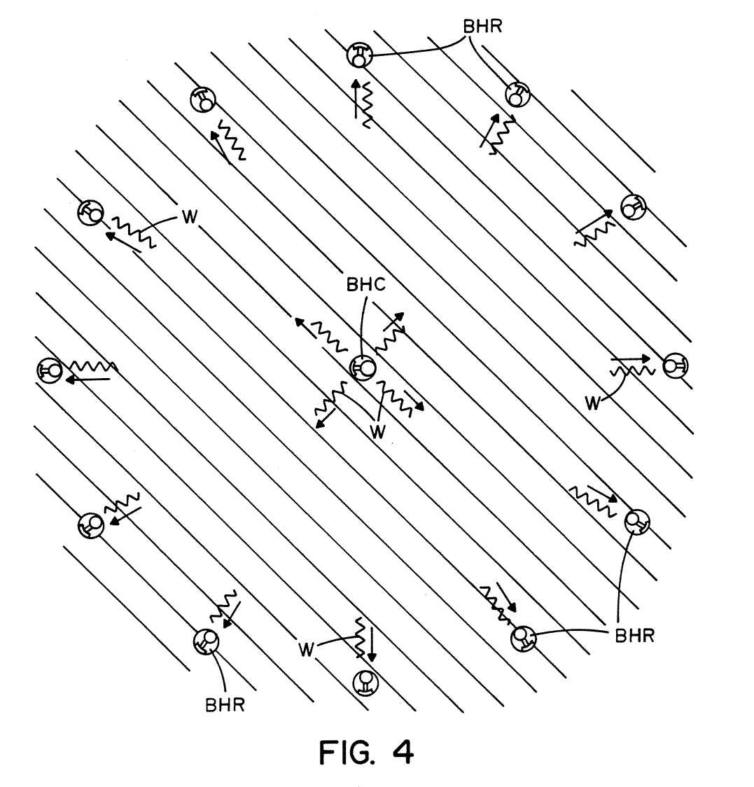

In another embodiment, a plurality of receivers can be used in connection with one or more drivers. This plurality of receivers can be multiple receivers at different heights or depths within the bore hole relative to the longitudinal axis as is shown in FIG. 3. In yet another embodiment, the multiple receives can be spaced at different spacing about the longitudinal axis as is shown in FIG. 4. In FIG. 4, shown is a central bore hole BHC and radial holes BHR which extend circumferentially about bore hole BHC. One or more drivers can be positioned in bore hole BHC and the receivers can be positioned in one or more bore holes BHR such that a large area of ground layer can be tested by a single waveform produced by the driver. In even yet another embodiment, multiple receivers can be used in one or more of bore holes BHR.

According to yet another embodiment, the invention of this application can be used in connection with a wide range of computer and/or communication hardware and software. In this respect, the invention of this application can be connected to an onsite computer or CPU 134 that can be utilized to operate any of the parameters of the operation of the device of this application. In this respect, motors M can be stepper motors wherein the computer and/or the operator can control the exact depth of the driver and/or receivers within the respective bore holes. This depth control can be coupled with an operating system that automatically changes the depth, engages and disengages the pressers and also controls the powering of the coils of the driver unit.

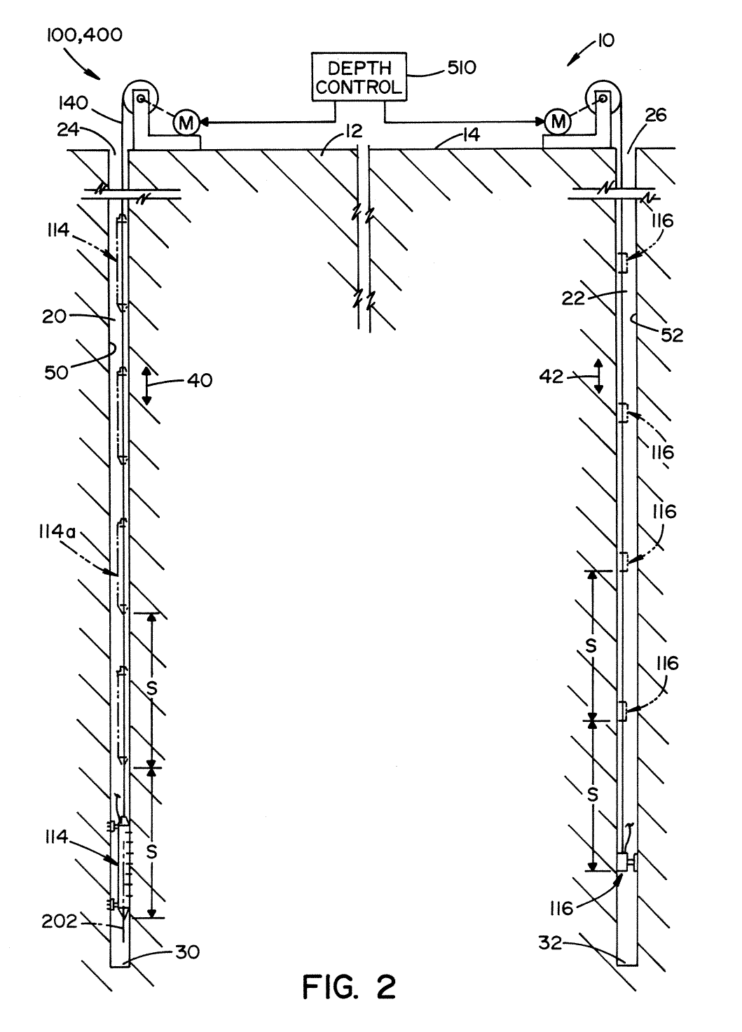

In one embodiment, once the operator in the field sets up the device, a software program can control the sending and receiving of waves at several heights/depths without the need for human interaction with the system. As is shown in FIGS. 2 and 3, the automated operation or even manual operation can be accomplished by utilizing a single driver and a single receiver that are joined to two stepper motors, or even a common stepper motor, that are both controlled by a depth control system 510 so that the exact change in height or spacing S is achieved for both the driver and the receiver wherein each wave is produced in the longitudinal direction for each cycle of operation. FIG. 2 shows an operation which includes five cycles each spaced by a distance S. As can be appreciated, FIG. 2 is merely an example and the invention of this application is not limited to five cycles or spacings. FIG. 3 shows a similar five cycle arrangement wherein five receivers are used in connection with a single driver which is moved longitudinally for each cycle of the operation.

In yet another embodiment, the device of this application can also include sending and/or receiving devices 600 and also storage capabilities which are known in the art. The data transmission and receiving systems can be any systems known in the art and can be for remote data and sending and on location data receiving and sending. In this respect, the bore holes for the driver and the receiver can be spaced over 100 feet away. Accordingly, wireless data transmission and receiving devices can be used to join or link the driver to the receiver. This can be for any reason to sustain the operation of the device of this application including, but not limited to, to synchronize the driver and the receiver to one another or to allow a common computer system to operate both the driver and the receiver including a common data store.

In yet another embodiment, the driver and the receiver could be connected to independent computing systems including independent storage devices, electronic or otherwise, that can run independently of one another or that can be connected to one another either by a wired connection or a wireless connection.

In yet another embodiment of the invention of this application, any of the operations associated with the devices of this application can be joined to transmitter/receiver 600 to communicate with a remote location wherein the remote location can merely be a data storage location or can be an operation center that has both data receipt and data transmission capabilities such that a single operator at a remote location can supervise and/or run the analyzing operation. The transmission of this data can be any data transmission means known in the art including, but not limited to, cell phone data transmission, satellite data transmission, infrared, radio based, and/or analog or digital radio based technology. As a result, operators on site or operators at a remote location can work together to perform the operation and to communicate any technical and/or data knowledge back and forth.

In yet further embodiments, one or more of the receivers can be located on the ground surface along with other receivers on the ground surface or in combination with any of the other receiver arrangements discussed above. Further, as with all receivers, these receivers can be any receiver known in the art including, but not limited to, geophones. In yet other embodiments, multiple receivers could be placed on the ground surface and strung together like the receivers shown in FIG. 2 so that a single wave is received by multiple receivers.

In even yet another embodiment, a single driver is placed at a single location and sends a signal out to multiple receivers. In this embodiment, and with reference to FIG. 2, the driver can be positioned at a central depth shown as driver 144a and multiple receivers 116 can be positioned in receiving bore hole 22 at several depths wherein the single wave produced by driver 114a is received by each of the receivers.

While considerable emphasis has been placed on the preferred embodiments of the invention illustrated and described herein, it will be appreciated that other embodiments and/or equivalents thereof can be made and that many changes can be made in the preferred embodiments without departing from the principles of the invention. Accordingly, it is to be distinctly understood that the foregoing descriptive matter is to be interpreted merely as illustrative of the invention and not as a limitation.

It is claimed:

1. A wave generating device for producing a shear wave in a ground layer wherein the generated wave emanates from a bore hole in the ground layer and passes through the ground layer toward a receiver spaced from the bore hole, the wave having a given waveform and the bore hole being defined by at least one bore wall that extends from a surface of the ground layer to a bottom extent of the bore hole, said device comprising: a driver having an outer layer extending in a longitudinal direction along a longitudinal axis and having a radially outwardly facing surface generally parallel to said longitudinal axis which is configured to engage an associated bore wall of an associated bore hole; said driver further including a coil assembly fixed relative to said outer layer, an inner assembly configured to move relative to said coil assembly, said inner assembly having at least one magnetic field emitter producing an inner magnetic field and said coil assembly having at least one coil of wire wherein said at least one magnetic field passes through said at least one coil, said device further including an electrical connection between said at least one coil of said driver and an associated power source, when the associated power source is in an on condition said outer layer vibrates longitudinally relative to said inner assembly thereby producing a wave in an associated ground layer extending outwardly from said device.

2. The wave generating device of claim 1, wherein said device further includes the power source and said power source includes an electronic wave emitter and an amplifier having an electronic input and output, said input being in electrical connection with said wave emitter and said output being in electrical connection with said at least one coil of said driver.

3. The wave generating device of claim 2, wherein said electronic wave emitter produces at least one of a sinusoidal wave, a triangle wave, an arbitrary waveform and a swept frequency wave.

4. The wave generating device of claim 1, further including a compass to help orient said driver in the bore hole about said longitudinal axis.

5. The wave generating device of claim 1, wherein said radially outwardly facing surface of said driver is generally cylindrical having a maximum diameter transverse to said longitudinal direction and the associated bore hole is cylindrical having a bore diameter, said maximum diameter being less than 75% of the bore diameter.

6. The wave generating device of claim 1, wherein said device further includes at least one side load presser joined to said driver, said presser selectively urging said outwardly facing surface of said driver transversely to said longitudinal direction such that said surface is forced against the associated bore wall.

7. The wave generating device of claim 6, wherein said at least one presser is a single presser including a housing and an actuator fixed relative to said housing, said actuator moving between a first position and a second position, said presser further including a presser plate and said driver being joined to said presser plate at a presser joint, as said actuator moves from said first position to said second position, said presser plate moving transversely from said longitudinal direction and away from said housing, said transverse movement producing said urging of said outwardly facing surface against said bore hole.

8. The wave generating device of claim 7, wherein said actuator includes a linear actuator fixed relative to said housing, said linear actuator extending in said longitudinal direction and actuating a cam and a cam follower to produce said transverse movement of said presser plate presser further includes a hanger joined to said frame, said hanger supporting said device in the associated bore hole.

9. The wave generating device of claim 7, wherein said presser joint includes a plurality of isolation bolts extending between said presser plate and said driver such that said presser is at least partially isolated from movement of said driver.

10. The wave generating device of claim 7, wherein said presser has a length in said longitudinal direction and said driver has a length in said longitudinal direction, presser length being greater than said driver length.

11. The wave generating device of claim 1, wherein said radially outwardly facing surface of said driver includes frictional enhancers to increase a frictional interengagement between said outer surface and the associated bore wall.

12. The wave generating device of claim 11, wherein said frictional enhancers include at least one of surface texturing, surface ridges, plates, ridges, and outwardly facing threads.

13. The wave generating device of claim 1, wherein said at least one magnetic field emitter are permanent magnets fixed to said inner assembly.

14. The wave generating device of claim 1, wherein said at least one magnetic field emitter are electro magnets fixed to said inner assembly.

15. The wave generating device of claim 1, wherein said inner assembly of said driver includes a central rod and said magnetic emitters being fixed to said central rod.

16. The wave generating device of claim 1, wherein said outer layer of said driver is formed by a lightweight material and said outer layer together with said coil assembly having an outer mass, said inner assembly having an inner mass, said inner mass being greater than said outer mass.

17. The wave generating device of claim 16, wherein said inner assembly further includes a weight to increase said inner mass.

18. The wave generating device of claim 1, further includes a biasing member joined between said inner assembly and said coil assembly, said biasing member mechanically biasing said inner assembly relative to said coil assembly at a predetermined neutral position.

19. The wave generating device of claim 18, wherein said biasing member includes at least one of a coil spring, an elastomeric spring and a leaf spring.

20. The wave generating device of claim 18, further including bumpers to limit longitudinal travel of said inner assembly relative to said coil assembly.

21. The wave generating device of claim 1, wherein said coil assembly includes a coil support, said coil support being generally tubular with an outer radial surface extending longitudinally which includes alternating longitudinally extending troughs and ridges, each of said troughs supporting one of said at least one coils of wire.

22. The wave generating device of claim 21, wherein said coil support is a plastic sleeve having a radially outwardly facing surface including said troughs and a longitudinally extending central passage, said inner assembly extending through said central passage.

23. The wave generating device of claim 21, wherein said at least one coil in said coil assembly is a plurality of coils spaced longitudinally from one another in said troughs, each said coil being wrapped about said longitudinal axis and said each coil being wrapped in an opposite direction of an adjacent one of said coils.

24. The wave generating device of claim 23, wherein said at least one magnetic field emitter is a plurality of magnetic emitters, each of said plurality of emitters having a north pole and a south pole and said each emitter being aligned such said north pole is longitudinally spaced from south pole and such that common poles of adjacent magnetic emitters face one another.

25. The wave generating device of claim 1, wherein said at least one coil in said coil assembly is a plurality of coils spaced longitudinally from one another, each said coil being wrapped about said longitudinal axis and said each coil being wrapped in an opposite direction of an adjacent one of said coils.

26. The wave generating device of claim 25, wherein said at least one magnetic field emitter is a plurality of magnetic emitters, each of said plurality of emitters having a north pole and a south pole and said each emitter being aligned such said north pole is longitudinally spaced from south pole and such that common poles of adjacent magnetic emitters face one another.

27. The wave generating device of claim 1, further including a bearing system between said inner assembly and said coil assembly reducing the friction therebetween.

28. The wave generating device of claim 1, further including a computing device having an operating system, said computing device being electrically joined to and automatically operating said power source.

29. The wave generating device of claim 28, further including a drive motor and a hanging support joined to said drive motor for raising and lowering said driver longitudinally in said bore hole, a side load presser and said presser selectively urging said outwardly facing surface of said driver against the associated bore wall, said computing device automatically operating said power source, said drive motor and said presser based on designated operating parameters to produce a shear wave at multiple locations in the associate bore hole at different times.

30. The wave generating device of claim 28, further including a temperature sensing device imbedded in said coil assembly, said sensing device monitoring at least one coil temperature of said at least one coil.

31. The wave generating device of claim 1, wherein said device produces a shear wave in said longitudinal direction in the associated ground layer.

32. A method of measuring a parameter in a layer of ground, said method including the steps of:
forming a bore hole in a ground layer, said bore hole being defined by at least one bore wall that extends from a surface of said ground layer to a bore extent of said bore hole in a longitudinal direction;
providing a wave generating device for producing a wave in said bore hole in said longitudinal direction; said device having a driver including an outer layer extending in said longitudinal direction along a longitudinal axis and having a radially outwardly facing surface generally parallel to said longitudinal axis which is configured to engage said bore wall of said bore hole, a coil assembly fixed relative to said outer layer, and an inner assembly configured to move relative to said coil assembly;
providing a receiver;
positioning said receiver at a given location spaced from said bore hole;
positioning said generating device in said bore hole at a given location in said longitudinal direction;
urging said generating device against said bore wall to form a frictional engagement between said radially outwardly facing surface and said bore wall;
vibrating said outer layer relative to said inner assembly thereby producing a wave in said longitudinal direction in said ground layer; and,
receiving said wave with said receiver.

33. The method of measuring according to claim 32, wherein said providing a receiver is providing a plurality of receivers and said positioning said receiver is positioning said plurality of receivers at different locations.

34. The method of measuring according to claim 33, wherein said different locations are different heights relative to said longitudinal axis.

35. The method of measuring according to claim 33, wherein said different locations are different spacing about said longitudinal axis.

36. The method of measuring according to claim 33, wherein said inner assembly includes at least one magnetic field emitter producing an inner magnetic field and said coil assembly includes at least one coil of wire wherein said at least one magnetic field passes through said at least one coil; said wave generating device further including a side load presser joined to said driver for said urging step, said presser includes a housing and a linear actuator fixed relative to said housing, said actuator extending in said longitudinal direction and actuating a cam and a cam follower such that movement of said linear actuator in said longitudinal linear actuator moves a presser plate in said transverse direction, said driver being joined to said presser plate.

37. A method of measuring a parameter in a layer of ground, said method including the steps of:
forming a bore hole in a ground layer, said bore hole being defined by at least one bore wall that extends from a surface of said ground layer to a bore extent of said bore hole in a longitudinal direction;
providing a wave generating device for producing a wave in said bore hole in said longitudinal direction; said device having a driver including an outer layer extending in said longitudinal direction along a longitudinal axis and having a radially outwardly facing surface generally parallel to said longitudinal axis which is configured to engage said bore wall of said bore hole, a coil assembly fixed relative to said outer layer, and an inner assembly configured to move relative to said coil assembly;
providing a receiver;
positioning said receiver at a given location spaced from said bore hole;
pressing said generating device into said bore hole to a given depth in said longitudinal direction;
vibrating said outer layer relative to said inner assembly thereby producing a wave in said longitudinal direction in said ground layer; and,
receiving said wave with said receiver.
